(19) United States
(12) Patent Application Publication
(10) Pub. No.: US 2011/0114763 A1
(43) Pub. Date: May 19, 2011

(54) PIVOT PIN FOR FURNACE SIDE REMOVAL

(76) Inventors: Oliver G. Briggs, JR., Jefferson, MA (US); Dennis N. Barlow, Somers, CT (US); Thomas J. Campanelli, Berlin, CT (US); Kevin T. Grzebien, Southwick, MA (US); James P. Sutton, South Windsor, CT (US)

(21) Appl. No.: 12/887,823

(22) Filed: Sep. 22, 2010

Related U.S. Application Data
(63) Continuation-in-part of application No. 12/618,031, filed on Nov. 13, 2009.

(51) Int. Cl. B05B 15/08; F16B 19/00

(52) U.S. Cl. 239/587.6; 411/500

(57) ABSTRACT

Disclosed herein is a novel pivot pin assembly 410, 420 430, 600 for pivotally attaching nozzle tips 200 to stationary nozzles in a solid fuel furnace. The pivot pin assemblies allow rapid replacement of the nozzle tips 200. The pivot pin assembly 410, 420 430, 600 employs fasteners that or recessed or have an aerodynamically shaped head 610. The head 610 includes a leading edge 613 and optionally a trailing edge 615 that are aerodynamically shaped to reduce corrosion and erosion. The pivot pin assembly pivotally attaches the nozzle tip 200 to the stationary nozzle 110. It employs fasteners that are accessible from a furnace side through a central opening of the nozzle tip 200. This allows removal of the nozzle tip 200 from inside the furnace greatly simplifying nozzle tip 200 replacement.

### CROSS REFERENCE TO RELATED APPLICATIONS

This application is a Continuation-In-Part of U.S. Ser. No. 12/618,031 “PIVOT PIN FOR FURNACE SIDE REMOVAL” by Briggs et al., filed Nov. 13, 2009 and claims priority from this application.

### BACKGROUND

1. Field of the Invention

This disclosure relates to burners of solid fuel fired furnaces and more specifically to a burner nozzle tip design that allows for easier removal and maintenance.

2. Discussion of Related Art

Solid fuel furnaces have many common uses, such as for firing boilers to produce steam and electricity. The solid fuel typically is pulverized coal. Coal particles of the pulverized coal is entrained in a flowing air stream and blown into a combustion chamber of a furnace where it is burned.

FIG. 1 is a schematic depiction of a fuel firing compartment 100 of a typical solid fuel fired furnace. FIG. 2 is a side elevational view showing a cross section of the nozzle, nozzle tip, and pivot pin shown in FIG. 1.

The invention will be described with reference to both FIGS. 1 and 2. It can be seen here that stationary nozzle 110 receives sold fuel particles entrained in a stream of flowing air. The air/fuel flows through the stationary nozzle 110 and out of the nozzle tip 200. The air/fuel is then burned in the combustion chamber of a solid fuel furnace. The direction following the flow is referred to as “downstream” and the opposite direction is referred to as “upstream”.

In order to adjust the operation of the nozzle tip 200, one or more control arms, shown here as a tilt pivot 120 and a tilt drive 130, adjust the orientation and operation of the nozzle tip 200. The nozzle tip 200 may be tilted with respect to the stationary nozzle 110 on a pivot pin 310 to cause the nozzle tip 200 to be directed in a different direction to optimize the firing of the furnace.

Since the air flow with entrained solid particles passes through the fuel-firing compartment 100 subject to erosion effects similar to sand blasting. Anything within the path of the air/fuel flow is eroded.

Since the nozzle tips 200 are located in the combustion chamber, they are also exposed to excessive heat and heat cycling. This can overheat and warp the nozzle tips, and have effects on the moving parts, such as pivot pin 310.

Combustion occurring near the nozzle tips 200 creates constant expansion, contraction and vibration. If the pivot pin is held in place with standard bolts or nuts, it is possible that they will loosen and vibrate out. This would cause the nozzle tip 200 to fall into the furnace. The furnace has a grinder for grinding up the ashes at the bottom of the furnace. Not only will there be uneven and uncontrolled burning, but the nozzle tip, bolt and nut will become caught in the grinder causing damage and the boiler to become non-operational. This would require time and expense to correct the problem.

For this reason, one end of the pivot pin is typically welded into place. The pins must be ground off to replace them. The inside of the furnace is covered with water tubes that pass close to each of the nozzle tips 200. Therefore, the only way to replace the nozzle tips is to grind or burn off the pivot pins from inside of the nozzle tips 200. There is little access to the nozzle tip 200 openings, making replacement difficult.

The entire fuel firing compartment, except for the nozzle tip 200 is located within a closed windbox compartment (not shown for clarity in FIG. 1). The common method of changing the nozzle tips 200 is to remove the entire fuel firing compartment 100 from the windbox and grind off the pivot pins from the outside of the nozzle tips 200. This is very time-consuming causing the power plant to be ‘down’ for quite a while.

Typically these solid fuel furnaces are used as steam generators to create electricity in power plants. When one of these power plants is ‘down’, the owner is required to buy and supply equivalent power from the power grid to provide an uninterrupted supply of electricity to its customers.

Buying this replacement electricity is much more expensive that generating it. This may amount to significant losses by being out of operation. Therefore, a significant part of the costs are ‘down time’ costs.

Since nozzle tip operate at very high temperatures and in an erosive environment, the nozzle tips 200 tend to have a short life relative to the other parts of the system and have to be replaced often.

Since the nozzle tips 200 typically require more maintenance then the remainder of the fuel firing compartment parts, it would be beneficial to be able to quickly and easily replace only the nozzle tip 200. This then results in a furnace that is less costly to operate and service.

### SUMMARY

The present invention may be embodied as a replaceable nozzle tip assembly 250 within a solid fuel furnace having a stationary nozzle 110. The nozzle tip assembly 250 includes a nozzle tip 200 having with shroud walls 210, 220 and a central opening 230.

A bearing 510, 520, 530 is fixed to the shroud walls 210, 220. The bearing 510, 520, 530 has a central orifice 511, 521, 531.

A pivot pin assembly 410, 420, 430 passes through the bearing orifice 511, 521, 531 and the sidewall of the stationary nozzle 110, to pivotally and removeably attach the nozzle tip 200 to the stationary nozzle 110. The pivot pin assembly 410, 420, 430 acts as a fastener that is accessible from the central opening 230. This allows easy replacement of the nozzle tip.

The present invention may also be embodied as a nozzle tip assembly 250 removeably attached to a stationary nozzle of a solid fuel furnace.

The nozzle tip assembly 250 includes a nozzle tip 200 having at least one outer shroud wall 210, 220 and at least one central opening 230.

A bearing 510, 520, 530 with a bearing orifice 511, 521, 531 is attached to the shroud wall 210, 220 of the nozzle tip 200.

A fastener base 413, 423, 433 is fitted into the bearing orifice 511, 521, 531 and extends at least partially through a sidewall of the stationary nozzle 110 allowing the stationary nozzle 110 to pivot relative to the fastener base 413, 423, 433 and nozzle tip 200.

A set screw 411, 421, 431 is used to secure the fastener base 413, 423, 433 to the bearing 510, 520, 530, the set screw 411, 421, 431 being accessible from the central opening 230 of the nozzle tip 200.

The invention may also be embodied as an aerodynamic pivot pin assembly 600 passing through a surface of a shroud 210 of a nozzle tip 200 for pivotally securing a nozzle tip 200 to a nozzle, having a head 610 inside of the nozzle tip 200, wherein the head 610 has decreasing thickness “t” from a top 619 to a leading edge 613 to minimize resistance to flow and erosion of head 610.

The head 610 may also be designed to decrease in width in a lateral dimension as it extends upstream to further minimize resistance to flow and erosion of head 610.

### BRIEF DESCRIPTION OF FIGURES

With reference now to the figures where all like parts are numbered alike;

FIG. 1 is a perspective view of a fuel firing compartment showing a nozzle tip and a pivot pin.

FIG. 2 is a side elevational view showing a cross section of the nozzle, nozzle tip, and pivot pin of FIG. 1.

FIG. 3 is a perspective view showing the inside of the nozzle tip of FIGS. 1, 2 with an exploded diagram of a pivot pin assembly according to the present invention.

FIG. 4 is an enlarged view of a portion of the nozzle tip and pivot pin assembly of FIG. 3.

FIGS. 5-7 are exploded perspective views of three different embodiments of a pivot pin assembly according to the present invention.

FIG. 8 is a partial view of a nozzle tip 200 from the furnace side showing another embodiment of a pivot pin assembly, as it would appear installed.

FIG. 9 is a perspective view showing the curvature of the outside surface of the head of the pivot pin according to one embodiment of the present invention.

FIG. 10 is a perspective view showing the inner side of the head of the pivot pin of FIG. 9.

FIG. 11 shows a top plan view of the pivot pin shown in FIGS. 9 and 10.

FIG. 12 is a side elevational view of the pivot pin of FIGS. 9-11.

FIG. 13 is a front elevational view of the pivot pin of FIGS. 9-12.

FIG. 14 is a bottom plan view of the pivot pin of FIGS. 9-13.

FIG. 15 is a partially cut-away view of the nozzle tip assembly of FIG. 8.

### DETAILED DESCRIPTION

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

The most direct way of replacing a nozzle tip 200 would be from the furnace side, if the pivot pin were not welded.

The inside of the furnace is covered with water pipes for collecting the heat and for creating steam. These burners may be many feet from the bottom of the furnace. Therefore, temporary scaffolding must be erected to allow access to the nozzle tips 200. This may be acceptable for light work, but any more involved work may cause accidents that would damage the water pipes and other equipment inside of the furnace. For this reason, it was common to work on the other side of the windbox and remove the entire fuel-firing compartment 100 for maintenance.

The present invention allows for easier and more economical replacement of the nozzle tips 200. A new pivot pin assembly design is used instead of the welded pivot pin design for holding the nozzle tip 200 in place. This new design allows for the pivot pin removal and installation from inside the furnace without grinding or cutting.

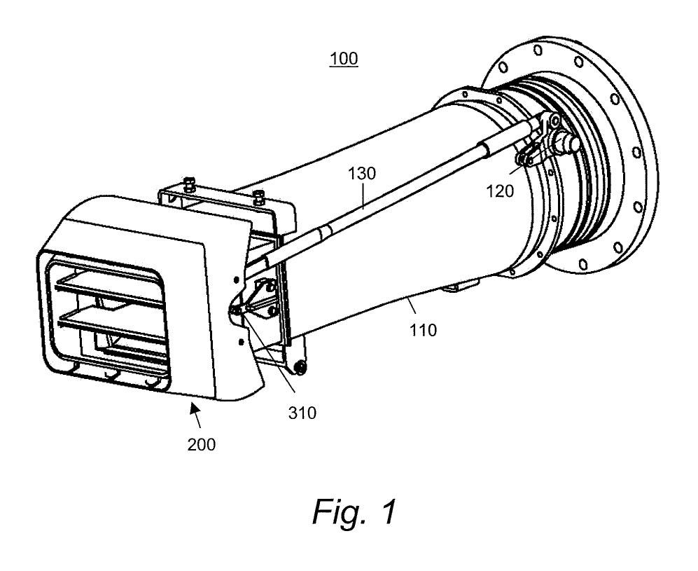

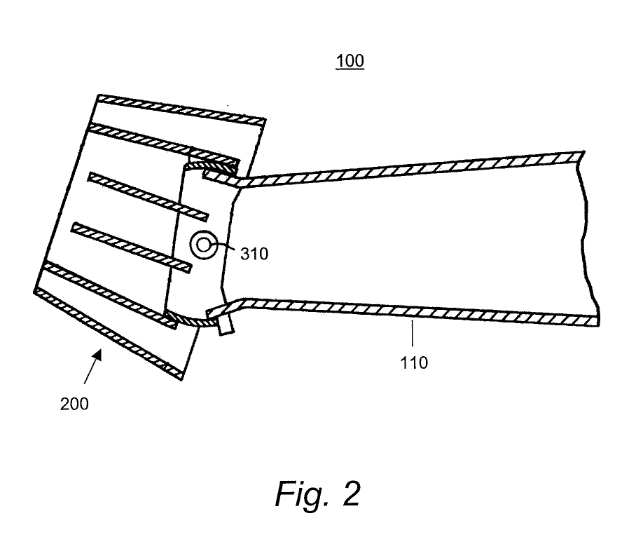

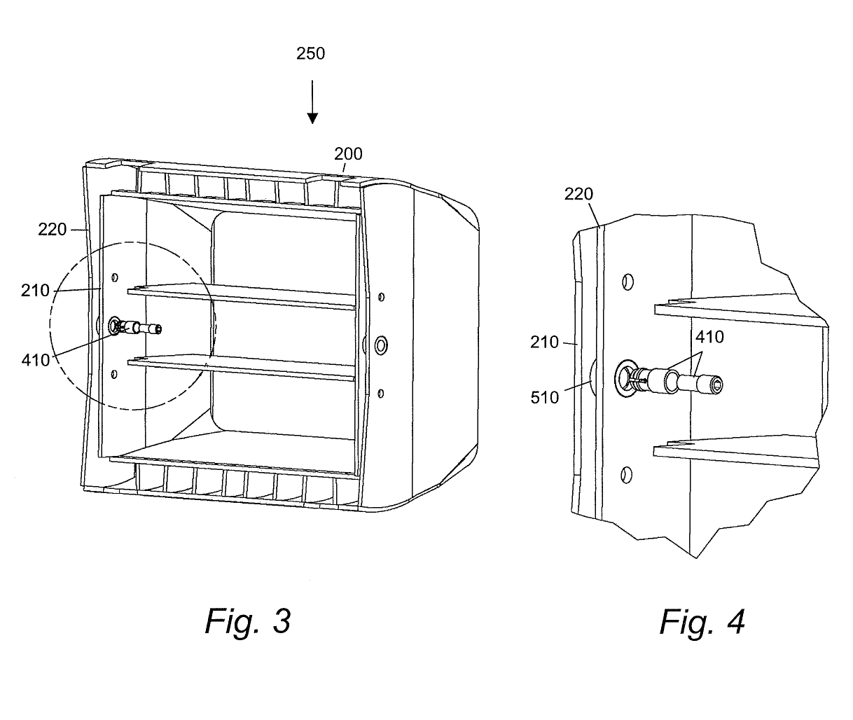

FIG. 3 is a perspective view showing the inside of the nozzle tip 200 of FIGS. 1, 2 with an exploded diagram of a pivot pin assembly 410 according to the present invention. Nozzle tip 200 has an outer shroud 220 that encloses an inner shroud 210. Pivot pin assembly 410 passes through the stationary nozzle (not shown here for clarity), the inner shroud 210 and the outer shroud 220. This allows nozzle tip 200 to pivot with respect to the stationary nozzle (110 of FIGS. 1, 2).

The pivot pin assembly 410 remains the same size as the pivot pin 310 currently being used. The pivot pin assembly 410, however, is manufactured to allow it to be removeably held in place using a fastener that is protected from the hazardous conditions.

FIG. 4 is an enlarged view of a portion of the nozzle tip and pivot pin assembly 410 of FIG. 3. In addition to the inner shroud 210, the outer shroud 220 and the pivot pin assembly 410, a portion of a bearing 510 is visible.

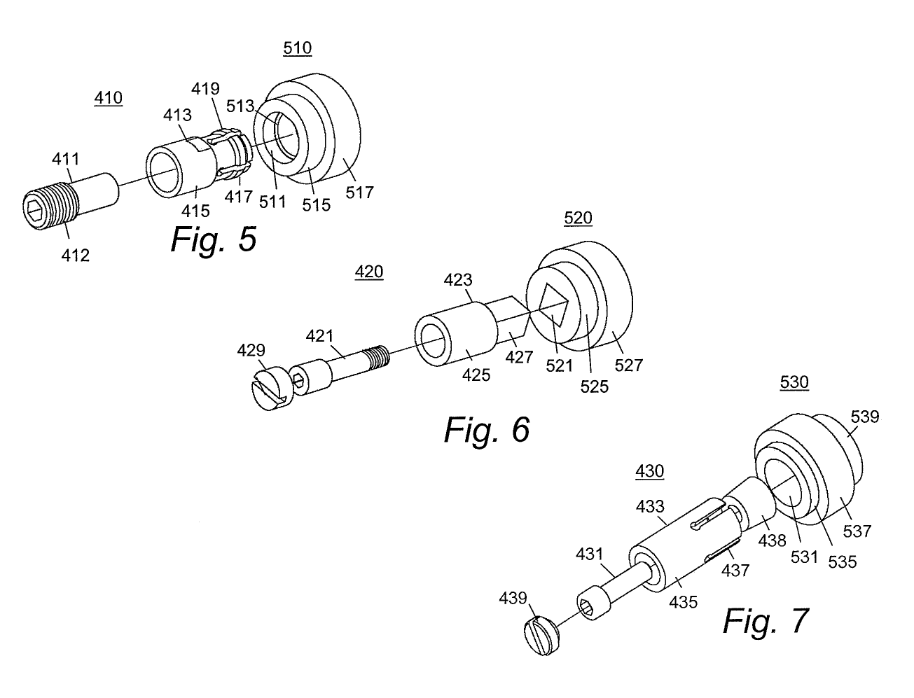

FIGS. 5-7 are perspective views of three different embodiments of a pivot pin assembly 410, 420, 430 according to the present invention that attach to bearings 510, 520, 530 in the nozzle tip. FIG. 5 shows a bearing 510 having an inner extension 515 that fits within the inner shroud (210 of FIG. 4), and a bearing body 517 that is sandwiched between the inner and outer shrouds (210, 220 of FIG. 4). Bearing 510 has a bearing orifice 511 that passes through the bearing 510.

A fastener base 413 has a cylindrical portion 415 and an expansion portion 417. The expansion portion 417 in its normal resting position is slightly larger diameter than bearing orifice 511. Expansion portion 417 has slits allowing it to be squeezed to make it thinner or released to expand back to make it thicker. The expansion portion 417 also has a snap ridge 419 that protrudes outward from the expansion portion 417. Bearing 510 also has a snap groove 513 that is designed to receive and removeably hold snap ridge 419. Cylindrical portion 415 extends outward enough to pass through a sidewall of stationary nozzle (110 of FIGS. 1, 2). Cylindrical portion 415 will be flush with respect to the inner surface of the sidewall of the stationary nozzle. (In an alternative embodiment, it may extend only partially through the stationary nozzle and be slightly recessed.) This insures that it will not be abrased away by the flowing air/fuel.

For assembly, fastener base 413 is pushed into bearing orifice 511. The leading edge of the extension portion 417 is preferably tapered to the center so as to squeeze expansion portion 417 together making it thinner until snap ridge 419 snaps into snap groove 513, holding fastener base 413 in place.

A set screw 411 has a threaded head section 412 and a body section. It is inserted into the fastener base 413 after the fastener base 413 has been inserted into bearing orifice 511. The body section restricts the expansion section 417 from reducing its thickness and prevents the snap ridge 409 from being removed from the snap groove 513. The head section 412 is threaded to thread into the outer end of the fastener base 413.

FIG. 6 is a second embodiment of the pivot pin assembly according to the present invention. Bearing 520 has a bearing body 527 sandwiched between the inner and outer shrouds (210, 220 of FIG. 4) of the nozzle tip when installed. A fastener base 423 has a cylindrical portion 425 and an insertion portion 427. The insertion portion 427 is inserted into the bearing orifice 521. Insertion portion 427 is shown here with a square cross sectional shape in this embodiment, however, any geometrical or irregular shaped cross section shape would be acceptable which matches the shape of the bearing orifice 521.

A set screw 421 passes through the fastener base 423 and screws into a threaded section fixed within bearing 520. This may be a threaded nut (not shown) welded within bearing orifice 521. The shape of insertion section 427 fitting snugly within bearing orifice 521 stops rotation of fastener base 423 restricting loosening of set screw 421.

A screw cap 429 threads into fastener base 423 thereby providing a corrosion-tight barrier protecting set screw 431 and fastener base 423. This screw cap 429 acts as a plug on the stationary coal nozzle side to seal the inner area from coal intrusion and wear. This also acts to jam against set screw 421 and acts as a lock nut in case set screw 421 begins to loosen.

In an alternative embodiment, cylindrical section 425 of fastener base 423 has internal threads. A screw cap similar to screw cap 429 may be employed and screwed into this cylindrical section 425 to protect fastener base 423 and prevent set screw 421 from loosening.

Cylindrical portion 425 extends outward enough to pass through a wall of the stationary nozzle (110 of FIGS. 1, 2), but it and screw cap 429 will be flush with respect to the inner surface of the stationary nozzle. In an alternative embodiment, they may extend only partially through the sidewall of the stationary nozzle and be slightly recessed. This insures that it will not be abrased away by the flowing air/fuel.

FIG. 7 shows a bearing 530 having a bearing body 537 that is sandwiched between the inner and outer shrouds (210, 220 of FIG. 4) of the nozzle tip when installed. Bearing 530 has an inner extension 535 that fits within the inner shroud (210 of FIG. 4), an outer extension 539 that fits within outer shroud (220 of FIG. 4) and a bearing body 537 that is sandwiched between the inner and outer shrouds (210, 220 of FIG. 4). Bearing 530 has a bearing orifice 531 that passes through the bearing 530.

A fastener base 433 has a cylindrical portion 435 and an expansion portion 437. The expansion portion 437 in its normal resting position has a diameter slightly smaller than bearing orifice 531. Expansion portion 437 has slits allowing it to be expanded to make it thicker.

Cylindrical portion 435 extends outward enough to pass through a wall of the stationary nozzle (110 of FIGS. 1, 2), but will be flush with respect to the inner surface of the stationary nozzle sidewall. In an alternative embodiment, it may extend only partially through the stationary nozzle and be slightly recessed. This insures that it will not be abrased away by the flowing air/fuel.

A set screw 431 has threads at one end. It is inserted through the fastener base 413 and loosely screwed into the narrower end of a truncated cone shaped expander 438.

The set screw 431, fastener base 433, and expander 438 are inserted into bearing orifice 531. Set screw 431 is then tightened causing expander 438 to be pulled toward set screw 431 thereby expanding expansion portion 437. Expansion portion 437 then becomes tightly held within bearing orifice 531.

A screw cap 439 is screwed into this cylindrical section 435 to protect fastener base 433 and prevent set screw 431 from loosening.

Even though a set screw is described in this embodiment, it is appreciated that the invention covers all types of removable fasteners that will allow the nozzle tip to pivot about the stationary nozzle, and be accessed from the furnace side of the nozzle tip.

As opposed to the prior art designed, with the present invention, a worker will not have to cut out material to replace the nozzle tip. No welding is required to install the present invention.

The present invention is designed to use existing holes in the stationary nozzle and nozzle tips 200. The embodiment of FIG. 7 also allows use of the existing bearing block sizing. In this embodiment, no new design sizing is required.

The present invention may be used to retrofit any existing ‘T fired’ nozzle types. The pivot pin assembly is sealed from wear. Since it attached with fasteners, it may be replaced with hand tools. No special rigging is required.

Even though this invention has its preferred use for solid fuel burner nozzle tips, and more specifically coal-fired burner nozzle tips, it is equally applicable to other nozzle tips that are intended to pivot and are located inside of a furnace. These may be oil burner nozzle tips, natural gas burner nozzle tips, other fuel gas nozzle tips and air inlet tips.

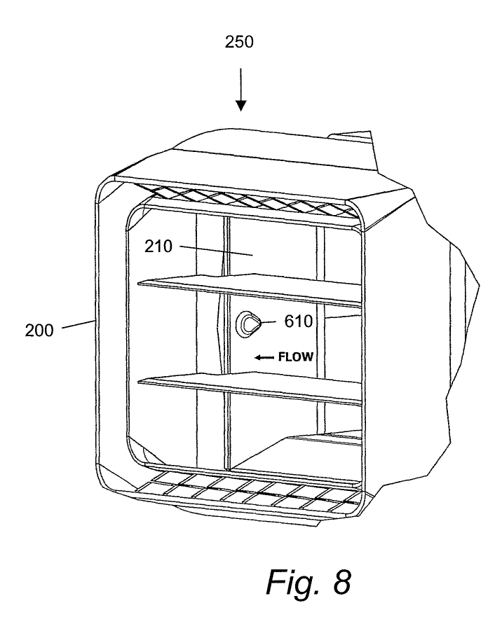

FIG. 8 is a partial view of a nozzle tip 200 from the furnace side showing a head 610 of a second embodiment of a pivot pin assembly 600, as it would appear installed.

A curved head 610 of the pivot pin assembly 600 is visible fitting flush against the surface of the inner shroud 210 of nozzle tip 200.

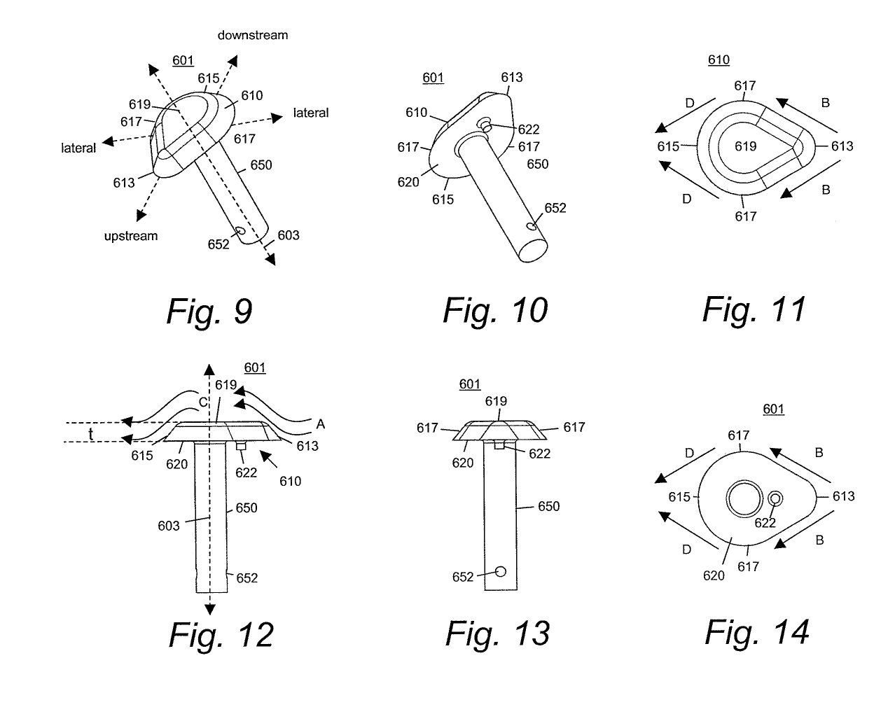

FIG. 9 is a perspective view showing the curved head of a pivot pin 601 of the pivot pin assembly according to one embodiment of the present invention.

FIG. 10 is a perspective view showing the inner side of the head of the pivot pin of FIG. 9.

FIG. 11 shows a top plan view of the pivot pin shown in FIGS. 9 and 10.

FIG. 12 is a side elevational view of the pivot pin of FIGS. 9-11.

FIG. 13 is a front elevational view of the pivot pin of FIGS. 9-12.

FIG. 14 is a bottom plan view of the pivot pin of FIGS. 9-13.

The pivot pin 601 is now described in connection with FIGS. 9-14.

FIGS. 9 and 12 show a pin axis 603 passing through the length of the shaft 650. Also, the indications of the upstream and downstream directions are shown, as well as the lateral direction.

In this embodiment, the pivot pin 601 includes a shaft 650. The shaft 650 fits through an orifice of a bearing held by the at least one of the shrouds similar to the embodiment shown in FIG. 4 or the other previously described embodiments. In this embodiment, the shaft 650 has a hole 652 that receives a clip, pin or other fastener on the other side of the shrouds, holding the pivot pin 601 in place.

Pivot pin 601 has a flat inner surface 620 on head 610 that fits flush against the inner shroud (210 of FIG. 8). The inner surface 620 also has an alignment peg 622 that fits into a corresponding hole in the inner shroud such that the pivot pin head is oriented to have a portion of the head 610 point upstream, a leading edge 613, and a portion face downstream, a trailing edge 615.

FIG. 9 shows the surface of the head 610. It is shaped to be aerodynamic with the head 610 being narrow at the leading edge 613, and increasing to a head thickness “t” at the top 619. It is curved, or angled to divert flow outward away from the inner shroud surface and around head 610 as shown by arrow “A” in FIG. 12.

It may also be designed to divert flow laterally around head 610 as show by arrows “B” in FIGS. 11 and 14.

Similarly, to reduce turbulence and abrasive swirling effects, the trailing edge 615 is designed to continue the smooth flow around the head 610 and downstream. In FIG. 12, the thickness of head 610 decreases from a maximum at the top 619 to a smaller thickness at the trailing edge 615. This causes the flow to follow arrow “C”.

The trailing edge 615 may also be aerodynamic in the other dimension. As shown in FIG. 14, the trailing edge 615 is rounded causing the flow to follow arrows “D”. It is to be understood that other aerodynamic shapes may also be advantageously used for the pivot pin head 610.

The gradual redirection of the flow around the head 610 minimized abrasion and erosion of the head. This allows these to function longer before replacement.

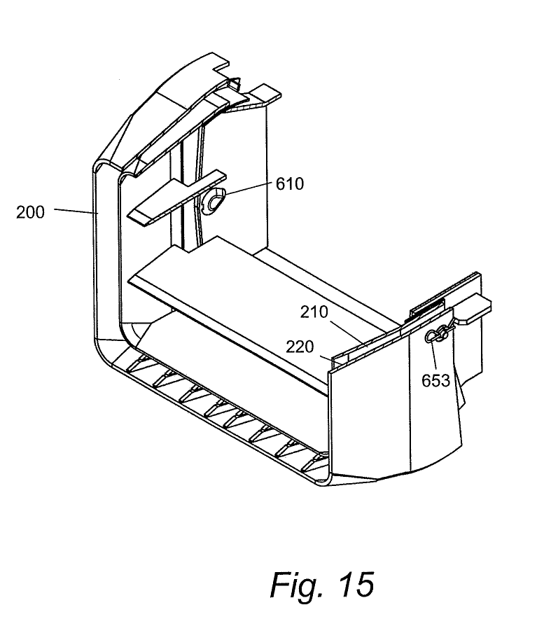

FIG. 15 is a partially cut-away view of the nozzle tip assembly of FIG. 8. Here, a clip 653 which fits through the hole of the pin shaft (652, 650 of FIGS. 9, 10, 12, 13, respectively).

Since these are design for quick replacement from inside the furnace, they are easily replaced when required.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A replaceable nozzle tip assembly within a solid fuel furnace having a stationary nozzle with at least one sidewall, wherein the nozzle tip assembly comprises:
a nozzle tip having at least one shroud wall and a central opening;
a bearing fixed to said shroud wall, the bearing having a orifice;
a pivot pin assembly for passing through the bearing orifice and said sidewall of the stationary nozzle, to pivotally and removeably attach the nozzle tip to the stationary nozzle, the pivot pin assembly acting as a fastener that is accessible from the central opening.

2. The replaceable nozzle tip assembly of claim 1 wherein:
the pivot pin assembly is accessible from within said furnace.

3. The replaceable nozzle tip assembly of claim 1 wherein the pivot pin assembly further comprises:
a corrosive-resistant removable screw cap.

4. The replaceable nozzle tip assembly of claim 1 wherein the pivot pin assembly includes a fastener base with an expansion section that expands within the bearing orifice to secure fastener base within the bearing orifice.

5. The replaceable nozzle tip assembly of claim 4 wherein the expansion portion includes snap ridge that snaps into and removeably holds a snap groove within the bearing orifice.

6. The replaceable nozzle tip assembly of claim 4 further comprising a set screw to attach the fastener base to the bearing.

7. The replaceable nozzle tip assembly of claim 6 further comprising:
a truncated wedge-shaped expander for receiving the set screw and for expanding expansion portion of fastener base as expander is pulled toward se screw.

8. The replaceable nozzle tip assembly of claim 1 wherein the pivot pin assembly includes a fastener base with an insertion section that has a shape complementary to that of the bearing orifice of bearing such that insertion section of fastener base fits securely within the bearing orifice preventing rotation of fastener base relative to bearing.

9. A nozzle tip assembly for removable attachment to a stationary nozzle of a solid fuel furnace, the stationary nozzle having at least one sidewall, the nozzle tip assembly comprising:
a nozzle tip having at least one outer shroud wall and at least one central opening;
a bearing having a bearing orifice, the bearing attached to said shroud wall;
a fastener base fitting into the bearing orifice and extending at least partially through the stationary nozzle sidewall allowing the stationary nozzle sidewall to pivot relative to the fastener base and nozzle tip;
a set screw for securing the fastener base to the bearing, the set screw being accessible from the central opening of the nozzle tip.

10. The nozzle tip assembly of claim 9, further comprising:
a corrosive-resistant removable screw cap.

11. The nozzle tip assembly of claim 9, wherein the fastener base employs an expansion portion that expands within the bearing orifice to secure the fastener base to the bearing.

12. The nozzle tip assembly of claim 9, wherein the fastener base employs an insertion portion that is shaped to securely fit within the bearing orifice to secure the fastener base to the bearing and prevent rotation of the fastener base relative to the bearing.

13. The nozzle tip assembly of claim 9, wherein the set screw is accessible from within said furnace.

14. The nozzle tip assembly of claim 9, wherein the expansion portion includes snap ridge that snaps into and removeably holds a snap groove within the bearing orifice.

15. The replaceable nozzle tip assembly of claim 1 wherein the pivot pin assembly includes a pivot pin having a head with an aerodynamic leading edge shaped to minimize resistance to flow and erosion of head.

16. The replaceable nozzle assembly of claim 15 wherein the head has an aerodynamic trailing edge shaped to minimize resistance to flow and erosion of head.

17. An aerodynamic pivot pin assembly passing through a surface of a shroud of a nozzle tip for pivotally securing a nozzle tip to a nozzle, comprising:
a head inside of the nozzle tip, wherein
the head has decreasing thickness from a top to a leading edge to minimize resistance to flow and erosion of head.

18. The aerodynamic pivot pin assembly of claim 17, wherein
the head has decreasing width in a lateral dimension as it extends upstream to minimize resistance to flow and erosion of head.

19. An aerodynamic pivot pin assembly of claim 17 wherein
the head has a decreasing thickness from a top to a trailing edge to minimize resistance to flow and erosion of head.

20. The aerodynamic pivot pin assembly of claim 17, wherein
the head has decreasing width in a lateral dimension as it extends downstream to minimize resistance to flow and erosion of head.

21. The aerodynamic pivot pin assembly of claim 17, wherein the head further comprises:
an alignment peg for securing the pivot pin in a desired orientation.
